(19) United States
(12) Patent Application Publication
(10) Pub. No.: US 2009/0283174 A1
(43) Pub. Date: Nov. 19, 2009

(54) FUEL RECLAMATION DEVICE

(76) Inventor: Steven C. Mitchell, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/248,113

(22) Filed: Oct. 9, 2008

Related U.S. Application Data
(60) Provisional application No. 61/053,689, filed on May 16, 2008.

(51) Int. Cl. B65B 1/04; F16K 31/44

(52) U.S. Cl. 141/1; 137/565.12

(57) ABSTRACT

A fuel reclamation device is provided for reclaiming fuel from a fuel line of an automobile. The fuel reclamation device includes a coupler having a reclamation outlet for providing reclaimed fuel and configured to fluidly connect with the fuel line and with an engine intake of the automobile.

This application claims priority to United States Provisional Patent Application No. 61/053,689 filed May 16, 2008.

### TECHNICAL FIELD AND BACKGROUND OF THE INVENTION

This application relates to a fuel reclamation device for reclaiming fuel out of an automobile.

Fuel reclamation has came into increasingly popular demand in the wake of higher energy prices. For example, automobile rental companies might reclaim fuel in an automobile's fuel tank before transporting the automobile to an auction for sale. Fuel can be reclaimed by simply attaching a line to an outlet at the bottom of the fuel tank and allowing the fuel to drain into a reclamation tank. However, attaching a line to the bottom of a fuel tank may require that the user climb underneath an automobile to gain access to the tank, provided that access is available at all, and that a reclamation tank be placed at a lower position than the fuel tank to allow proper drainage. This process relies on pressure difference due to the height differences between the tank and reclamation tank, and accordingly, may be a very slow and tedious process. In other instances, fuel may be reclaimed by inserting a siphon or pump operated tube through the fuel tank inlet nozzle. However, many fuel tanks are equipped with a series of anti-theft devices that block the insertion of siphons or pump operated tubes through the fuel tank inlet nozzle.

Alternatively, a user could try to reclaim fuel within the intake rail of a automobile's engine, but this may be disadvantageous because fuel within the fuel rail has to first pass through a Schroder valve in the fuel rail. This creates a very slow process of reclaiming fuel and is also disadvantageous for cost reasons. Also, fuel reclamation systems may not be universally adaptable. A typical rental car lot may have over 70 models of automobiles available and the fuel reclamation devices of the prior art systems may not fit all of the different makes and models, or may be tedious to install. Finally, fuel reclamation devices may not function in a time efficient manner due to slow install time or fuel pumping time.

Accordingly there remains a need for a fuel system reclamation device and method for reclaiming fuel that is adaptable for all cars, has sufficient pump speed, minimal waste, and is easily installed.

### SUMMARY OF THE INVENTION

Therefore it is an object of the invention to provide a fuel reclamation device.

It is another object of the invention to provide a fuel reclamation device that can quickly and efficiently connect with a fuel rail of an automobile.

It is another object of the invention to provide a fuel reclamation device that has a control valve for maintaining the automobile in a running state while reclaiming fuel.

It is another object of the invention to provide a method for reclaiming fuel from an automobile.

These and other objects of the present invention are achieved in the preferred embodiments disclosed below by providing a fuel reclamation device. The fuel reclamation device includes a coupler having a reclamation outlet for providing reclaimed fuel and configured to fluidly connect with the fuel line of the automobile at a first outlet and to fluidly connect with an engine intake at a second outlet.

According to another embodiment of the present invention, pressure from a fuel pump of the automobile provides fluid pressure to the fuel line of the automobile.

According to another embodiment of the present invention, the reclamation devices includes a reclamation tank for storage of reclaimed fuel.

According to another embodiment of the present invention, the reclamation device includes a line connecting the reclamation tank and the reclamation device.

According to another embodiment of the present invention, the reclamation device includes a shut off valve for restricting fluid flow to the reclamation tank.

According to another embodiment of the present invention, the reclamation device includes a metering valve fluidly connected to the coupler for metering the flow of fluid to the engine intake for maintaining the automobile engine in a running condition and providing reclaimed fuel to the reclamation outlet.

According to another embodiment of the present invention, the reclamation device includes a pump for providing fluid pressure to the fuel line of the automobile.

According to another embodiment of the present invention, the reclamation device includes a metering valve fluidly connected to the coupler for metering flow of fluid to the engine intake for maintaining the automobile engine in a running condition and providing reclaimed fuel to the reclamation outlet.

According to another preferred embodiment of the present invention, a fuel reclamation device for reclaiming fuel from a fuel line of an automobile is provided and includes a coupler having a first outlet configured to fluidly connect with the fuel line of the automobile, a second outlet configured to fluidly connect with an engine intake rail of an automobile, and a third outlet for providing reclaimed fuel. A metering valve is fluidly connected with the coupler for metering the flow of fuel between the second outlet and the third outlet. A fuel pump provides pressure to the fuel line and the metering valve is adjustable so that the engine may be placed in a running condition while providing reclaimed fuel to the third outlet.

According to another embodiment of the present invention, the fuel pump is an automobile fuel pump.

According to another embodiment of the present invention, the fuel pump is an external pump.

According to another embodiment of the present invention, the running condition is an idling condition.

According to another embodiment of the present invention, the reclamation device includes a reclamation tank connected to the coupler by a fuel line.

According to another preferred embodiment of the present invention, a method for reclaiming fuel from a fuel line of an automobile is provided and includes the steps of providing a fuel reclamation device comprising a coupler configured to fluidly connect with the fuel line of the automobile at a first channel and to fluidly connect with an engine intake at a second channel of the automobile and having a third channel for providing reclaimed fuel, connecting the first channel to the fuel line of the automobile, connecting the second channel to the engine intake of the automobile, providing a pumping source to pump fuel to the fuel line, whereby fluid pressure within the fuel line provides fluid pressure to the third channel, and reclaiming fuel from the third channel.

According to another embodiment of the present invention, the step of providing a pumping source includes providing an automotive fuel pump of the automobile.

According to another embodiment of the present invention, the method further includes the step of providing a metering valve fluidly connected to the coupler for metering the flow of fluid to the engine intake for maintaining the engine in a running state.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a side view of a fuel reclamation device according to the present invention;

FIG. 2 is a perspective view of a fuel reclamation device according to the present invention;

FIG. 3 is an enlarged perspective view of a fuel reclamation device according to the present invention;

FIG. 4 is an enlarged perspective view of a fuel reclamation device according to the present invention;

FIG. 5 is a perspective view of a fuel reclamation device in a disconnected position according to an embodiment of the invention; and

FIG. 6 is a perspective view of a fuel reclamation device connected with an intake rail of an automobile.

### DESCRIPTION OF THE PREFERRED EMBODIMENTS AND BEST MODE

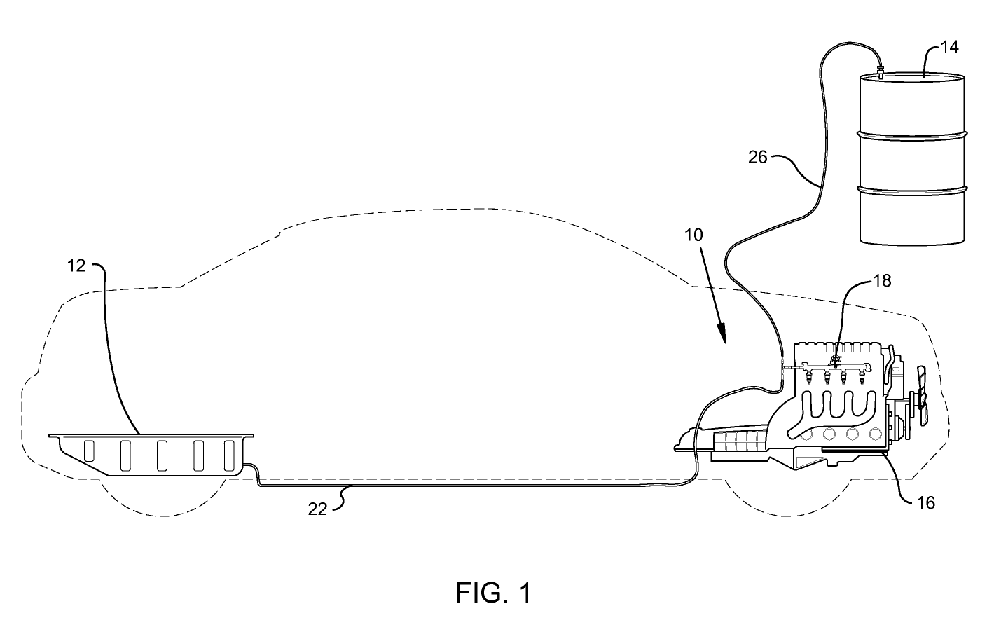

Referring now specifically to the drawings where like elements are represented by like referenced numerals, a fuel reclamation device 10 is generally shown in FIG. 1. The fuel reclamation device 10 is a T shaped coupler with three outlets. The fuel reclamation device 10 connects with the intake rail 18 of an automobile engine 16 at one outlet and with a fuel line 22 of the automobile at another outlet. The fuel line 22 of the automobile is connected with a fuel tank 12 of the automobile. The fuel tank 12 may be any suitable variety and is located within many locations. A dump line 26 is provided and is connected with the remaining outlet of the T shaped coupler 36, and is for providing reclaimed fuel to an external location. The dump line 26 extends into a fuel reclamation tank 14 placed at an external location. The fuel reclamation tank 14 may be located on the floor of a garage, or also on a vehicle suitable for transporting the fuel reclamation tank 14.

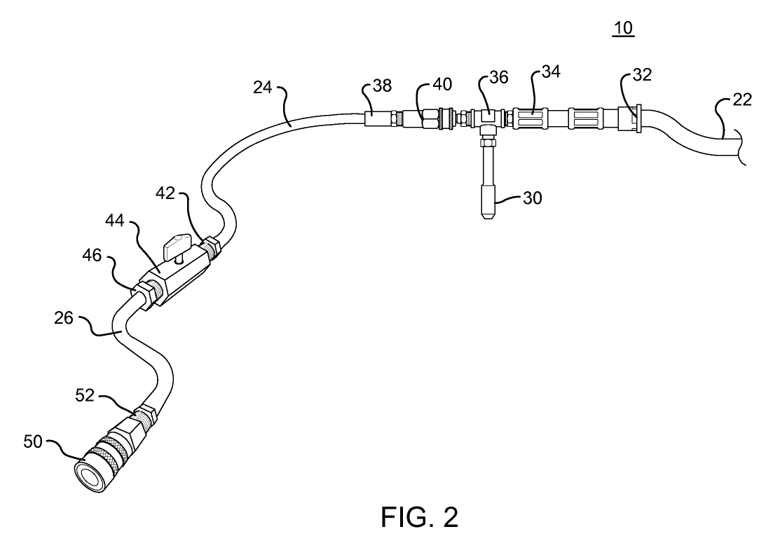

FIG. 2 shows the fuel reclamation device in greater detail. As discussed in regards to FIG. 1, the T shaped coupler 36 is connected at one outlet to the fuel line 22 of the automobile. The fuel line 22 is connected by the use of a quick connect fuel line fitting 32 that is adaptable to fit fuel lines of most modern automobiles. The quick connect fuel line fitting 32 may be selected and interchanged in order to adapt to different fuel line sizes depending on the make of the automobile. This quick connect fuel line fitting 32 may be a pinch type, slip joint, or equivalent type of connector. The quick connect could also be a simple hose with an exterior hose clamp or a male tapered member designed to fit tightly within the fuel line. In this manner, the fuel reclamation device 10 is designed to reclaim fuel out of most modern automobiles. The fuel reclamation device 10 is able to connect within the intake rail 18 of a vehicle at outlet 30, generally termed the fuel reclamation outlet 30. In this manner, the fuel reclamation outlet 30 is able to fluidly connect within the connection where the fuel line 22 is ordinarily connected with the intake rail 18.

A fuel line connector 40 is provided to connect with the T shaped coupler 36. The fuel line connector has a male and a female portion, where the male portion is configured to fit flush within the female portion, thereby providing a fluid tight connection. A fuel line fitting 38 having a threaded portion is threaded into the fuel line connector 40. An optional intermediated dump line 24 is connected with the fuel line fitting 38 and runs into another fuel line fitting 42. This fuel line fitting 42 connects with a metering valve 44 configured to monitor fluid flow into the dump line 26. The metering valve 44 is connected to the dump line 26 by another fuel line fitting 46. In some embodiments, the intermediate dump line 24 will not be necessary and the T shaped coupler 36 will connect directly with the metering valve 44. The metering valve 44 may be any other suitable type of valve and in some embodiments may be omitted from the fuel reclamation device 10. Fuel line fitting 52 is connected on the other end of the dump line 26 and connects with another fuel line connector 50. This fuel line connector 50 connects with a fuel reclamation tank 14 and is connected by a mating male shaped coupler 54 known in the art. Addition or deletion of fuel line fittings or connections and substitution with hard connected lines may be appropriate in some instances.

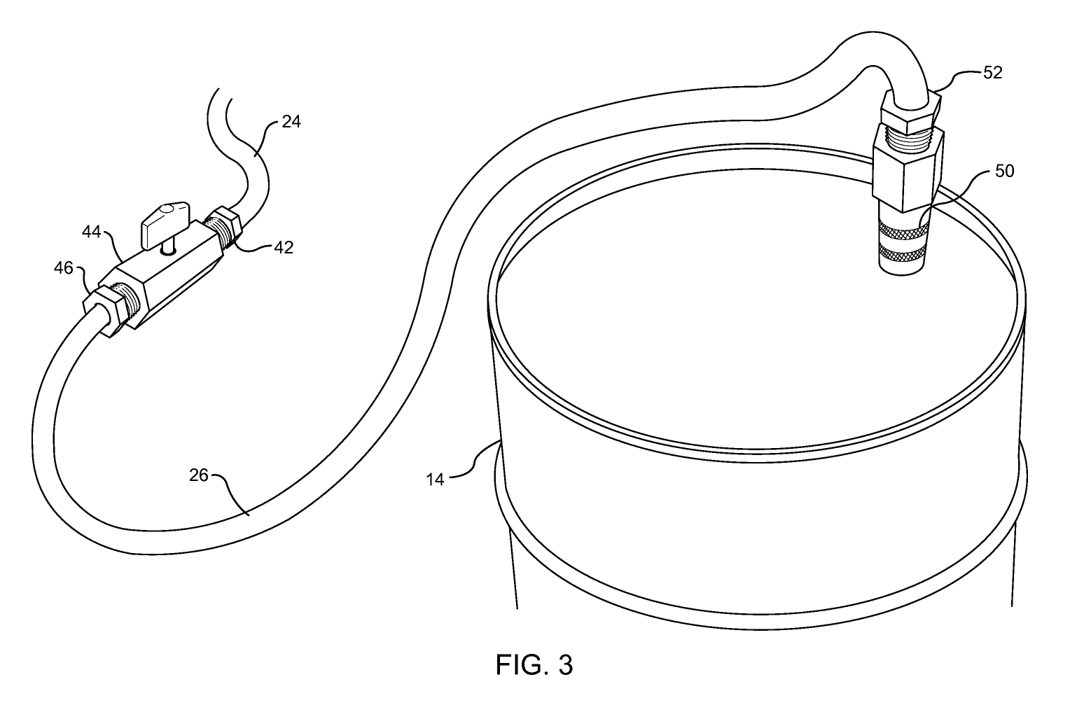

FIG. 3 shows the dump line portion of the fuel reclamation device in greater detail than that shown in FIG. 2. The dump line 26 connects with the fuel line fitting 52 that is threaded into the fuel line connector 50. The metering valve 44 controls flow into the fuel reclamation tank 14. The metering valve 44 serves at least two purposes. First the metering valve 44 may restrict all fluid flow into the reclamation tank 14. The metering valve 44 may also be used to meter fuel flow into the reclamation tank 14 so that enough fuel flows into the intake rail so that the automobile may be in a running state.

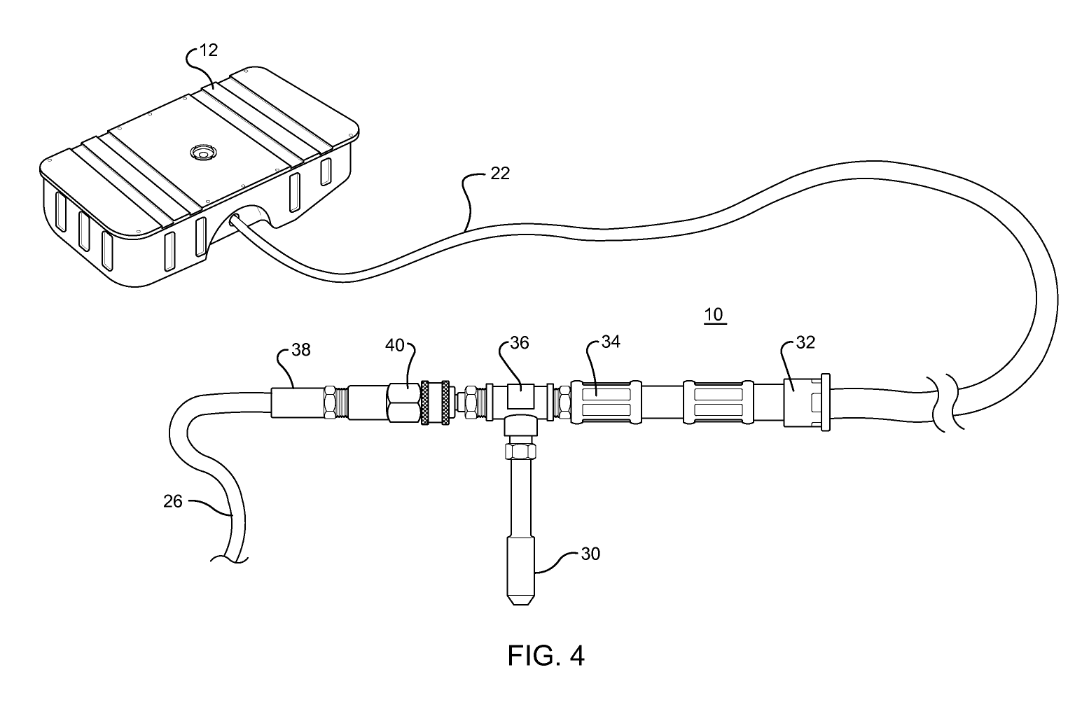

FIG. 4 shows the fuel line portion of the fuel reclamation device in greater detail than is shown in FIG. 2. As shown in FIG. 4, the fuel line may 22 may be connected to the fuel tank 12 in any standard manner. A fuel pump located at the tank or anywhere within the flow of fuel provides a pumping force to the fuel line and pumps fuel into the fuel reclamation device 10. Fuel reclamation outlet 30 is designed to fit within the fuel line fitting of the intake rail 18 and can be selected so as to match appropriate sized automobile engine intake rails.

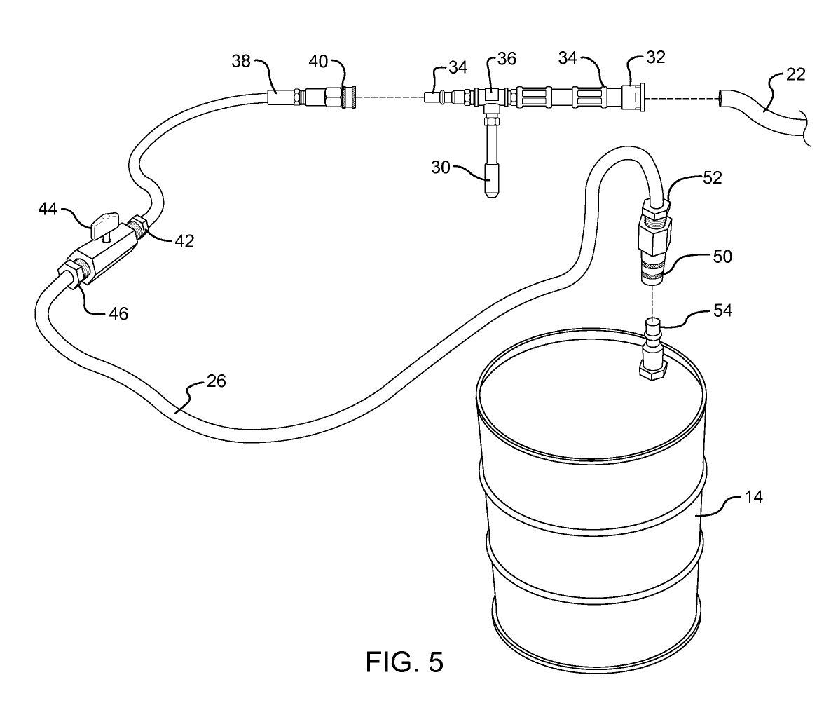

FIG. 5 shows the fuel reclamation device where the connections are unattached. Male connector ends 34 and 54 are designed to fit within female fuel line connectors 40 and 50, respectively. The fuel line hose is also shown disconnected from the line quick connect 32. This provides quick assembly, disassembly, and replacement of parts if needed.

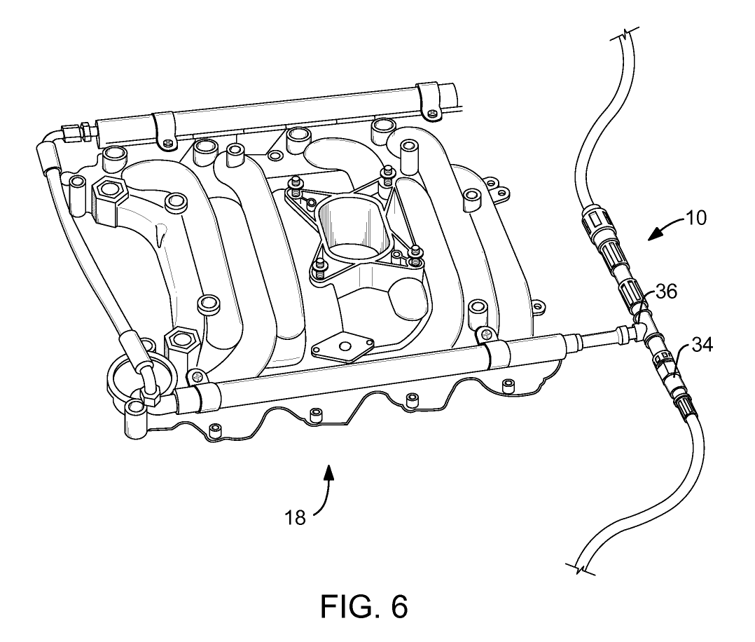

FIG. 6 shows the fuel reclamation device 10 attached to the fuel rail 18. The fuel rail 18 provides a gas/air fuel mixture to the engine 16. The fuel rail 18 may be a double rail as shown in the drawings, or a single rail depending on the make and model of the automobile.

In operation, the fuel reclamation device is attached to the fuel rail 18 at fuel reclamation outlet 30 and to the fuel line 22 at the outlet corresponding to the quick connect 32. The dump line 26 or intermediate line 38 may be connected to the dump outlet, defined by male connector 34, of the T shaped connector 36. The operator then starts the automobile and the fuel pump begins to pump fuel towards the fuel reclamation device 10 through fuel line 22. The fuel reclamation device 10 works to simultaneously channel fuel into the intake rail 18 and into the dump line 26 or intermediate line 24 depending on the embodiment employed. This assures that the automobile continues to run while reclaiming fuel and that the check engine light is not activated on the on board diagnostics found on most common cars. The operator may initiate throttle response to the automobiles accelerator to increase the amount of fuel provided to the fuel reclamation device 10. In this manner, sufficient fuel may be provided to engage the throttle assembly into a full throttle position during normal operating conditions, but will only provide sufficient fuel to maintain the automobile engine in an idling state, thus channeling excess fuel into the reclamation tank 14. The operator may monitor engine performance and alter the rate of fuel provided to the engine 16 or reclamation tank 14 by adjustment of the metering valve 44. Closing the metering valve 44 provides more fuel to the engine 16, while opening the metering valve 44 provides more fuel to the reclamation tank 14.

In the desired operation, the fuel reclamation device operates by pumping pressure from the fuel tank of the automobile while the automobile is in the running state. In an alternative embodiment, the fuel reclamation device may be configured to further include a pump fluidly connected with the fuel reclamation device for providing additional or complete fuel pump pressure. In this manner, the fuel reclamation process may be expedited and be provided for vehicles in a non running condition.

Furthermore, fuel may be reclaimed out of multiple vehicles simultaneously by attaching multiple fuel reclamation devices to multiple vehicles. Also in another alternative embodiment, the fuel reclamation device may be connected within the fuel line and not be connected with the fuel rail. In this manner, the coupler would be connected on a first end with the fuel line, one a second end with another portion of the fuel line, and a third end at the dump line.

A fuel reclamation device is described above. Various details of the invention may be changed without departing from its scope. Furthermore, the foregoing description of the preferred embodiment of the invention and the best mode of practicing the invention are provided for the purpose of illustration only and not for the purpose of limitation.

1. A fuel reclamation device for reclaiming fuel from a fuel line of an automobile comprising a coupler having a reclamation outlet for providing reclaimed fuel and configured to fluidly connect with the fuel line at a first outlet and with an engine intake of the automobile at a second outlet.

2. The fuel reclamation device according to claim 1, wherein pressure from a fuel pump of the automobile provides fluid pressure to the fuel line of the automobile.

3. The fuel reclamation device according to claim 2, further including a reclamation tank for storage of reclaimed fuel.

4. The fuel reclamation device according to claim 3, further including a fuel line connecting the reclamation tank and the reclamation device.

5. The fuel reclamation device according to claim 3, further including a shut off valve for restricting fluid flow to the reclamation tank.

6. The fuel reclamation device according to claim 2, further including a metering valve fluidly connected to the coupler for metering the flow of fluid to the engine intake, thereby maintaining the automobile engine in a running condition and providing reclaimed fuel to the reclamation outlet.

7. The fuel reclamation device according to claim 1, further including a pump for providing fluid pressure to the fuel line of the automobile.

8. The fuel reclamation device according to claim 7, further including a metering valve fluidly connected to the coupler for metering flow of fluid to the engine intake for maintaining the automobile engine in a running condition and providing reclaimed fuel to the reclamation outlet.

9. A fuel reclamation device for reclaiming fuel from a fuel line of an automobile comprising:
(a) a coupler having a first outlet configured to fluidly connect with the fuel line of the automobile, a second outlet configured to fluidly connect with an engine intake rail of an automobile, and a third outlet for providing reclaimed fuel; and
(b) a metering valve fluidly connected with the coupler for metering the flow of fuel between the second outlet and the third outlet, wherein a fuel pump provides pressure to the fuel line and the metering valve is adjustable so that the engine may be placed in a running condition while providing reclaimed fuel to the third outlet.

10. The fuel reclamation device according to claim 9, wherein the fuel pump is an automobile fuel pump.

11. The fuel reclamation device according to claim 9, wherein the fuel pump is an external pump.

12. The fuel reclamation device according to claim 9, wherein the running condition is an idling condition.

13. The fuel reclamation device according to claim 9, further including a reclamation tank connected to the coupler by a fuel line.

14. A method for reclaiming fuel from a fuel line of an automobile comprising the steps of:
providing a fuel reclamation device comprising a coupler having three outlets and configured to fluidly connect with the fuel line of the automobile at the first outlet and to fluidly connect with an engine intake at a second outlet and having a third outlet for providing reclaimed fuel;
connecting the first outlet to the fuel line of the automobile;
connecting the second outlet to the engine intake of the automobile;
providing a pumping source to pump fuel to the fuel line, wherein fluid pressure within the fuel line provides fluid pressure to the third outlet; and
reclaiming fuel from the third outlet.

15. The method according to claim 14, wherein the step of providing a pumping source includes providing an automotive fuel pump of the automobile.

16. The method according to claim 14, further including the step of providing a metering valve fluidly connected to the coupler for metering the flow of fluid to the engine intake and to the third outlet for maintaining the engine in a running state.
